(19) United States
(12) Patent Application Publication
(10) Pub. No.: US 2026/0217991 A1
(43) Pub. Date: Jul. 30, 2026

(54) INTUMESCENT COATING COMPOSITIONS WITH IMPROVED CHAR FORMATION AND FIRE RESISTANCE

(71) Applicant: SWIMC LLC, Cleveland, OH (US)

(72) Inventors: Sharon L. HILTON, Bolton (GB); Raymond J. WEINERT, Jr., Macedonia, OH (US); Patrick D. ZIEMER, Parma, OH (US)

(21) Appl. No.: 19/148,102

(22) PCT Filed: Jan. 9, 2024
(86) PCT No.: PCT/US2024/010800

§ 371 Date: Jul. 15, 2025

Related U.S. Application Data
(60) Provisional application No. 63/480,235, filed on Jan. 17, 2023.

(51) Int. Cl. C09D 5/18; C09D 5/02; C09D 7/63; C09D 7/65

(52) U.S. Cl. CPC C09D 5/185; C09D 5/024; C09D 7/63; C09D 7/65

(57) ABSTRACT

A water-based liquid intumescent coating composition comprising a modified binder resin component is described herein. The binder resin component comprises at least one polymeric component, one or more ethylenically unsaturated co-monomer components and at least one intumescent ingredient. The coating composition is curable to a solid state in a free-radical polymerization reaction. The described composition demonstrates improved char formation and passive fire resistance.

### BACKGROUND OF THE INVENTION

The present description provides liquid intumescent coating compositions, specifically water-based intumescent coatings, that have particular, but not exclusive, application in protecting steel structures in a fire situation.

The term “intumescent” is derived from the term “to intumesce,” which was used by the tragedian John Webster (1580-1624) in the Elizabethan period with two meanings: “to grow and to increase in volume against the heat” or “to show an expanding effect by bubbling.” Accordingly, intumescent coating compositions are commonly used to protect structural steel components in buildings against the effects of cellulosic fire conditions.

Intumescent coatings typically contain a resin system “pigmented” with various intumescent ingredients that under the influence of heat, react together to produce an insulating foam or “char”, having low thermal conductivity, which has a volume many times that of the original coating. This char greatly reduces the rate of heating experienced by the steel, thus extending the time before the steel loses its integrity and the building collapses, thereby allowing additional time for safe evacuation.

Intumescent coatings of the type known to those of skill in the art are described at least in U.S. Pat. No. 8,784,705, along with prior art coating systems and general background information in the art.

Essentially an intumescent polymer must remain melt-elastic and decompose into a self-supporting char that (a) deprives the propagating flame front of fuel through decomposing into a self-supporting char that is insulating due to its foam structure, (b) evolution of a gas that attacked the free-radicals and smothers the flame (i.e. deprives the flame of oxygen), and (c) cools the fire (char or releasing water lowering the energy).

For a waterborne intumescent to be effective, there is a critical point at about 350° C. where the intumescent polymer degradation (loss of solids) stabilizes (slows down) as a char is formed and gas is evolved i.e. large amount of gas evolving from a blowing agent in the intumescent paint from about 350° C. up to about 420° C.

The lack of solid-loss and the formation of a “molten polymer” (~350-420° C.) results in gas entrapment as the char is created resulting in a self-supporting thermal insulating foam which is highly dependent on well-formed bubbles and the char reaches a critical insulating thickness. Simultaneously, the degradation of the entire formulation, including the polymer, occurs over the same temperature range providing thermal insulation. It is envisioned that the polymer is viscoelastic in the melt with sufficient viscosity to trap bubbles. The emulsion polymer must easily incorporate the flame retardant additives utilized in an intumescent coating and must wet the fillers easily.

The time-to-failure (TTF) of an intumescent coating is improved by development of an insulating char during burning that slows the heat transfer during a fire to the steel. The insulating property of the polymeric coating slows or prevents the steel in the structure that is on fire from reaching 500° C. At about this temperature the steel's microstructure changes and it is no longer load bearing.

To date, water-based intumescent coatings have shown certain deficiencies. In particular, water-based vinyl acrylic intumescent coatings are sensitive to water, and therefore, their use is largely limited to building interiors.

From the foregoing, it will be appreciated that what is needed is a robust intumescent waterborne polymeric product that demonstrate improved char formation and enhanced passive fire resistance, such that when placed in an applied coating results in the increased survivability of steel structures and thus improves the safety of people in those structures via extending the TTF of steel structures.

### SUMMARY

The present description provides an optimal fire protection coating with improved char formation and enhanced fire resistance.

In an embodiment, a water-based liquid intumescent coating composition is described herein. The composition includes a binder resin with a vinyl ester emulsion and at least one ethylenically unsaturated comonomer. In addition, the coating composition described herein also includes a blowing agent and an intumescent additive package that includes at least one of an acid source and a carbon source.

In another embodiment, a method for making a water-based liquid intumescent coating composition is described herein. The method includes steps for providing a binder resin component having a vinyl ester emulsion and at least one ethylenically unsaturated comonomer. A free radical initiator is utilized to polymerize monomers into a latex binder.

The polymerized latex is then combined with a blowing agent and an intumescent additive package to produce the intumescent coating composition described herein.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set forth in the description below. Other features, objects, and advantages of the invention will be apparent from the description and drawings, and from the claims.

### Selected Definitions

Unless otherwise specified, the following terms as used herein have the meanings provided below.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, tetrabutyl (t-butyl), heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group or an aromatic group, both of which can include heteroatoms. The term “alicyclic group” means a cyclic hydrocarbon group having properties resembling those of aliphatic groups. The term “Ar” refers to a divalent aryl group (i.e., an arylene group), which refers to a closed aromatic ring or ring system such as phenylene, naphthylene, biphenylene, fluorenylene, and indenyl, as well as heteroarylene groups (i.e., a closed ring hydrocarbon in which one or more of the atoms in the ring is an element other than carbon (e.g., nitrogen, oxygen, sulfur, etc.)). Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “heteroarylene” groups (e.g., furylene, pyridylene, etc.)

A group that may be the same or different is referred to as being “independently” something. Substitution is anticipated on the organic groups of the compounds of the present invention. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

The term “(meth)acrylic acid” includes either or both of acrylic acid and methacrylic acid, and the term “(meth)acrylate” includes either or both of an acrylate and a methacrylate.

The term “component” refers to any compound that includes a particular feature or structure. Examples of components include compounds, monomers, oligomers, polymers, and organic groups contained there.

The term “double bond” is non-limiting and refers to any type of double bond between any suitable atoms (e.g., C, O, N, etc.). The term is used interchangeably with “ethylenically unsaturated” herein.

Unless otherwise indicated, the term “polymer” includes homopolymers, copolymers and terpolymers (i.e., polymers of two or more different monomers).

The term “resin composition” or “binder resin composition” or “binder resin component” as used herein refers to the resin-containing portion of the coating composition. The binder resin component may include one or more resins or polymer compositions derived from one or more monomers, a mixture of monomers, and the like. The terms are used interchangeably herein with “polymer” or “polymer composition.”

A “latex” or emulsion of polymer particles formed in the presence of water and one or more secondary dispersing or emulsifying agents (e.g., a surfactant, alkali-soluble polymer or mixtures thereof) whose presence is required to form the dispersion or emulsion. The secondary dispersing or emulsifying agent is typically separate from the polymer after polymer formation. In some embodiments a reactive dispersing or emulsifying agent may become part of the polymer particles as they are formed.

The phrase “low VOC” when used with respect to a liquid coating composition means that the coating composition contains less than about 10 weight % volatile organic compounds, more preferably less than about 7% volatile organic compounds, and most preferably less than about 4% volatile organic compounds based upon the total liquid coating composition weight.

The term “water-dispersible” in the context of a water-dispersible polymer means that the polymer can be mixed into water (or an aqueous carrier) to form a stable mixture. For example, a mixture that readily separates into immiscible layers is not a stable mixture. The term “water-dispersible” is intended to include the term “water-soluble.” In other words, by definition, a water-soluble polymer is also considered to be a water-dispersible polymer. The term is used interchangeably herein with “water-based.”

The term “dispersion” in the context of a dispersible polymer refers to the mixture of a dispersible polymer and a carrier. The term “dispersion” is intended to include the term “solution.”

The term “crosslinker” refers to a molecule capable of forming a covalent linkage between polymers or between two different regions of the same polymer. A particular component is termed “crosslinkable” if it can react with another component via a crosslinking reaction, either via a self-crosslinking reaction or through the reaction of two or more polymers or between two different regions of the same polymer.

The term “self-crosslinking,” when used in the context of a self-crosslinking polymer, refers to the capacity of a polymer to enter into a crosslinking reaction with itself and/or another molecule of the polymer, in the absence of an external crosslinker, to form a covalent linkage therebetween. Typically, this crosslinking reaction occurs through reaction of complimentary reactive functional groups present on the self-crosslinking polymer itself or two separate molecules of the self-crosslinking polymer.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

The term “substantially free,” as used herein, refers to a component present in an amount of preferably less than 5%, more preferably less than 2%, and even more preferably less than 1%.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The following detailed description is merely exemplary in nature and is not intended to limit the disclosure. Furthermore, there is no intention to be bound by any theory presented in the preceding background or the following detailed description.

In particular, various steps in the manufacture of such compositions are well-known and so, in the interest of brevity, many conventional steps will only be mentioned briefly herein or will be omitted entirely without providing the well-known process details.

The present description provides a water-based liquid intumescent coating composition. The composition includes a binder resin with a vinyl acrylic aqueous system or vinyl ester emulsion and at least one ethylenically unsaturated comonomer. In addition, the coating composition described herein also includes a blowing agent and an intumescent additive package that includes at least one of an acid source and a carbon source.

The incorporation of specific ethylenically unsaturated comonomers into a vinyl acrylic aqueous based systems produces particularly beneficial properties to the described coating composition. Specifically, the comonomers provide improvements in (a) extended char time, (b) improved char expansion, (c) improved water resistance, and (d) minimal slumping via the incorporation of specific monomers to an aqueous vinyl-acrylic system as measured by lab-based tests described herein.

In at least one embodiment, the intumescent coating composition described herein includes a binder resin component. The binder resin component includes a polymeric component, specifically a vinyl acrylic aqueous system or vinyl ester emulsion. As used herein, the vinyl ester emulsion is derived from at least one monomer selected from vinyl toluene, vinyl chloride, vinyl acetate, vinylidene chloride, vinyl versatate esters, and vinyl esters of long-chain fatty acids such as vinyl neodeconate, commercially available as VEOVA 10. Co-reactants may include dienes such as butadiene. In a preferred aspect, a mixture of monomers is used to make the vinyl acrylic emulsion, with vinyl acetate as the preferred monomer.

In an aspect, the vinyl ester emulsion described herein is substantially or even completely free of styrene. Without limiting to theory, it is believed that styrene and its derivatives block the copolymerization reaction between the vinyl ester emulsion and other ethylenically unsaturated comonomers in the system. Therefore, it is necessary for the vinyl ester emulsion described herein to be substantially free of styrene, i.e. to have less than about 5 wt %, preferably less than about 2 wt %, more preferably less than about 1 wt % of styrene in the system, based on the total weight of the binder resin component. In a most preferred aspect, the vinyl ester emulsion is completely free of styrene and/or its derivatives.

In at least one embodiment, the vinyl ester emulsion may include one or more additional acrylic monomers. These monomers are selected from ethyl acrylate, ethyl methacrylate, n-butyl methacrylate, isobutyl methacrylate, t-butyl methacrylate, 2-ethylhexyl acrylate, methyl acrylate, ethyl acrylate, n-butyl acrylate, isobutyl acrylate, t-butyl acrylate, 2-ethylhexyl methacrylate, hydroxyethyl methacrylate (HEMA) and mixtures or combinations thereof.

In a preferred aspect, the additional acrylic monomer is a hydroxy-functional (meth)acrylate, such as, for example, hydroxyethyl methacrylate. Without limiting to theory, it is believed that a hydroxy-functional (meth)acrylic monomer improves slumping, char structure and water resistance and slows the rate of expansion, providing optimal performance for a liquid intumescent coating composition.

In an embodiment, in the binder resin component described herein, the vinyl acrylic emulsion is preferably present in an amount of 50 to 80 wt %, more preferably 60 to 70 wt %, based on the total weight of the binder resin component. The binder resin component is present is amount of about 10 to 60 wt %, preferably 20 to 50 wt %, based on the total weight of the composition.

In at least one embodiment, the intumescent coating composition described herein includes a binder resin component. The binder resin component includes, in addition to the vinyl ester emulsion as described herein, at least one ethylenically unsaturated comonomer, preferably a mixture of two or more ethylenically unsaturated comonomers. As used herein, the at least one ethylenically unsaturated comonomer is a cyclic or aromatic (meth)acrylate monomer. Suitable ethylenically unsaturated comonomer useful in the composition described herein include, without limitation, isobornyl (meth)acrylate, cyclohexyl (meth)acrylate, benzyl (meth)acrylate, and mixtures or combinations thereof. Of these, isobornyl methacrylate (IBOMA) and cyclohexyl methacrylate (CHMA) are preferred.

Surprisingly, and in contravention of conventional wisdom in this area, it was found that the introduction of a suitable ethylenically unsaturated comonomer, particularly isobornyl (meth)acrylate, cyclohexyl (meth)acrylate, benzyl (meth)acrylate, and mixtures or combinations thereof, improves slumping, char structure, water resistance and slows the charring process, providing optimal performance characteristics for a liquid intumescent coating composition.

In an embodiment, in the binder resin component described herein, the at least one ethylenically unsaturated comonomer is preferably present in an amount of 1 to 25 wt %, more preferably 5 to 20 wt %, based on the total weight of the binder resin component. The binder resin component is present is amount of about 10 to 60 wt %, preferably 20 to 50 wt %, based on the total weight of the composition.

One or more initiators are added prior to use to convert the liquid coating to a solid state on the substrate. These are required to initiate the free-radical curing mechanism necessary to convert the monomeric (and oligomeric) components to a solid state. The initiators may be compounds suitable for free radical curing in a water-based system, i.e. a water-soluble free radical initiator. Suitable examples include, without limitation, persulfate compounds, AZO compounds, and mixtures or combinations thereof, and the like. Preferably, the water-soluble free radical initiator described herein is a persulfate compound. Suitable examples include, without limitation, any of the following either alone or in combination: hydrogen peroxide, tert-butyl peroxide, alkali metal persulfates such as sodium, potassium and lithium persulfate, ammonium persulfate, and mixtures of such initiators with a reducing agent. In a preferred embodiment, the free radical initiator used herein is ammonium persulfate.

The amount of initiator is preferably from 0.01 wt-% to 3 wt-%, based on the total amount of the monomeric components.

The initiators described herein can be used together with reducing agents such as sodium formaldehyde-sulfoxylate, ferrous salts, sodium dithionite, sodium hydrogen sulfite, sodium sulfite, sodium thiosulfate, as redox catalysts in amounts of 0.01% to 3% by weight, for example, 0.01% to 1% by weight, based on the total amount of the dispersion. The free-radical-formers can be charged in the aqueous emulsifier solution or can be added during the polymerization in doses. In one embodiment, the reducing agent Bruggolite FF6™ is employed in the polymerization process. FF6 comprises three sulfur-based reducing agents: (i) 2-Hydroxy-S-Sulfinatoacetic acid, di-sodium salt (50-60%); (ii) sodium sulfite (30-35%); and (iii) 2-Hydroxy-2-sulfonatoacetic acid, di-sodium salt (10-15%).

It is possible for the total amount of initiator system to be included in the initial charge to the reactor at the beginning of the polymerization. Preferably, however, a portion of the initiator is included in the initial charge, and the remainder is added after the polymerization has commenced, in one or more steps or continuously, or as part of a chase solution that includes both initiator and reducing agent.

The coating compositions described herein are intumescent coating compositions that contain specific ingredients that react together under the influence of heat from a fire, to form a protective insulating foam or char. These ingredients should be of low solubility to ensure that the coating has an acceptable level of durability, and maintains its integrity throughout the service life of the coating.

The intumescent ingredients preferably consist of three components, an acid source, a carbon source and a spumific or gas source or blowing agent. Preferably an inorganic “nucleating agent” should be present and optionally additives, which may be solid or liquid in nature, may be added to aid char formation and strengthen the char.

Under the influence of heat (between 100° C. and 200° C.) the resin components melt and begin to flow. As the temperature increases (>200° C.) the acid source, usually by decomposition, produces copious amounts of acid which can react with other constituents in the coating. If the acid source is ammonium polyphosphate, polyphosphoric acids are released which can react with polyhydric alcohols such as pentaerythritol (carbon source) to form polyphosphoric acid esters. The decomposition of these esters leads to the formation of carbon compounds, which together with a blowing agent such as melamine, give rise to a carbon foam or char.

The intumescent coating compositions of the present invention ideally contain at least one acid source, examples of which include ammonium polyphosphate, melamine phosphate, magnesium sulphate and boric acid. The preferred acid source is ammonium polyphosphate.

Ammonium polyphosphate can vary in molecular weight (chain length), the lower the molecular weight, the higher the solubility. By having very high molecular weight and a cross-linked structure it is possible to have very low water solubility, though higher thermal stability is observed. The crosslinking and molecular weight of the binder must be optimized to permit expansion into a foam that will eventually form a self-supporting char that constitutes an insulating layer. Coating ammonium polyphosphate with silane, melamine or melamine formaldehyde is beneficial in further reducing solubility and can also lead to higher loadings due to a reduction in resin absorbing properties. The use of coated ammonium polyphosphate is preferred, and ammonium polyphosphate coated with melamine formaldehyde is most preferred.

The acid source preferably constitutes from preferably 10% to 65%, more preferably 20% to 50% by weight of the intumescent ingredients content of the coating composition.

The intumescent coating compositions of the present invention ideally contain at least one carbon source, examples of which include polyhydric alcohols such as pentaerythritol, and dipentaerythritol. Starch and expandable graphite are other possible carbon sources. The preferred carbon sources are pentaerythritol and dipentaerythritol or a combination of the two.

The carbon source preferably constitutes from preferably 1% to 40%, more preferably 5% to 20% by weight of the intumescent ingredients content of the coating composition.

The intumescent coating compositions of the present invention ideally contain at least one gas source, examples of which include any of: melamine, melamine phosphate, melamine borate, melamine formaldehyde, melamine cyanurate, tris-(hydroxyethyl) isocyanurate (THEIC), ammonium polyphosphate or chlorinated paraffin. The resin itself may be a gas source as it undergoes decomposition. The preferred gas source is melamine.

The gas source preferably constitutes from 1% to 40%, more preferably 5% to 20% by weight of the intumescent ingredients content of the coating composition.

Although not an essential ingredient in intumescent reactions, inorganic “nucleating” agents are a preferred ingredient since they promote sites for the intumescent char to form, improve the thermal resistance properties and stability of the intumescent char during a fire. The intumescent coating compositions of the present invention ideally contain at least one nucleating agent, examples of which include titanium dioxide, zinc oxide, aluminum oxide, silica, silicates, heavy metal oxides such as cerium oxide, lanthanum oxide and zirconium oxide, mica and bentonite clay. A preferred nucleating agent is titanium dioxide which also provides opacity to the coating.

The nucleating agent preferably constitutes from 1% to 25% by weight of the intumescent ingredients content of the coating composition.

Further optional additives may be optionally included as part of the intumescent ingredients to aid char formation and to strengthen the char and prevent char degradation. Such additives include solids such as zinc borate, zinc stannate, zinc hydroxystannate, glass flake, glass spheres, polymeric spheres, fibers (ceramic, mineral, glass/silica based), aluminium hydroxide, antimony oxide, boron phosphate, fumed silica.

The total intumescent ingredients ideally constitute from 40% to 85% of the total coating composition. More preferably the total intumescent ingredients constitute from 50% to 75% of the total coating composition.

In order that the intumescent coating compositions of the present invention can be applied at high film thickness in a single coat application it is preferred to modify the rheology of the coating by the incorporation of a thixotrope. Suitable thixotropic additives include organically modified inorganic clays such as bentonite clays, hectorite clays or attapulgite clays, organic wax thixotropes based on castor oil and fumed silica. The most preferred thixotropic additives are wax thixotropes and fumed silicas.

The thixotropic additive preferably constitutes from 0% to 2% of the total coating composition. A more preferred level is from 0.05% to 1%.

To improve or facilitate dispersion of the intumescent ingredients and also to reduce the overall viscosity of the intumescent coating, it may be necessary to incorporate wetting/dispersion additives. Such additives are usually liquid in form and can be supplied either containing a solvent or be solvent free. Where required preferably a solvent free wetting agent is used, even more preferably a wetting agent with acid functionality is recommended, at levels between 0% to 2% by weight of the intumescent coating composition.

The thickness of the coating is ideally at least 250 μm.

Suitable preferred methods of application of the aforesaid compositions include airless spray, brush, roller, trowel and dipping. Airless spray is most preferred. Airless spray pumps having a ratio of 45:1 or greater, and preferably 60:1 are suitable. A minimum air pressure of greater than 60 psi and preferably 80 psi is required, and the compositions are sprayed using a tip size ranging from 0.015 inch and 0.035 inch.

The coating compositions of the present invention can be applied in liquid form to steel sections up to several meters in length with a gauge thickness typically ranging from 5 mm to 30 mm or greater. Depending on the Hp/A of the steel section coating can be applied at the required thickness to achieve up to 120 minutes fire protection.

Steel sections requiring fire protection are normally blast cleaned prior to the application of an intumescent coating to remove millscale and other deposits that may lead to premature failure of the intumescent coating, either on prolonged atmospheric exposure or during a fire situation.

If a primer is required, examples of suitable primers are coatings based on epoxy, modified epoxy (such as modified with polyvinyl butyral), polyurethane, acrylic, vinyl and chlorinated rubber. Primers based on epoxy are preferred.

The thickness of the primer is ideally in the range from 15 microns to 250 microns. Preferably the thickness should be in the range from 25 microns to 100 microns.

A topcoat may be applied to the cured intumescent coatings of the present invention, particularly to provide color to exposed steelwork. A topcoat if correctly formulated will also enhance the durability of the intumescent coating compositions. A clear sealer may also be suitable.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts, ratios, and percentages are by weight and all molecular weights are number average molecular weight (Mn). An exemplary coating composition as described herein may include additional materials in varying concentrations. For example, the composition may further include one or more fillers, wet and dry flow agents, adhesion promoters, and combinations thereof. Unless otherwise specified, all chemicals used are commercially available.

### Test Methods

Unless indicated otherwise, the following test methods were utilized in the Examples that follow.

### A. Laboratory Meker Test

The fire-retardant properties of the coating composition described herein were assessed using the laboratory Meker test. In this method, a steel test panel (grit-blasted and measuring 150 mm×100 mm×3 mm) or alternatively pre-primed aluminum Q-panel (0.32 mm) was sprayed with the coating composition and allowed to dry for 7 days at room temperature (23° C.; 50% relative humidity) to form a coated test panel with dry film thickness (DFT) of 0.1 to 1 mm. The panel was then mounted vertically approximately 5 cm from the head of a Meker burner that is mounted horizontally, causing the flame to impinge on the test panel surface at a 90° angle. After 5 minutes, the burner is turned off and the panel was allowed to cool in position. The formed foam is then assessed for char thickness (mm), char expansion ratio (ratio of char thickness to dry film thickness), and the time taken for the charring foam to complete expansion (seconds).

### Example 1. Preparation of Latex

Exemplary latex emulsions 1 to 8 as described herein were prepared by homogenizing monomer components of the type and amount provided in Table 1 to form a monomer mixture for each composition. A control formulation based on a commercially available product is also provided. Unless otherwise indicated, the amounts indicated in Table 1 are percentages by weight, based on the total weight of the monomer mixture.

To a reaction vessel, water was added along with surfactants and Natrosol (cosurfactant) and sodium bicarbonate, and then heated to a temperature of about 50° C. to 85° C. until all the components dissolved. About 5 wt % of the monomer mixture was added to a reaction flask and allowed to mix for minutes. Ammonium persulfate dissolved in water was then added to the reaction vessel while stirring and allowed to react for 30 minutes to form a seed.

In a separate vessel, surfactant was added and dissolved in water. To the surfactant mixture, ammonium persulfate initiator is then dissolved.

The remaining monomer mixture and the surfactant/initiator solutions were added slowly over 4 hours to the reaction vessel while stirring (careful to maintain an appropriate vortex). The addition of monomer and surfactant/initiator mixtures were completed at about the same time.

The final monomer solution in the reaction vessel was allowed to polymerize an additional 2 hours. The polymer was then cooled to 60° C. and chase solutions A and B (as shown below) added over a 30-minute period.
Solution A: Bruggolite FF6 at 0.19 phm at a concentration water 3.4 wt % in water
Solution B: t-Butyl hydroperoxide 0.19 phm at a concentration of 3.4 wt % in water
   The resulting latex was filtered, and then formulated into a coating formulation.

TABLE 1
Monomers Used in Latex Preparation

| Monomer | Control | 1 | 2 | 3 | 4 | 5 | 6 | 7 | 8 | 9 | 10 |
|---|---|---|---|---|---|---|---|---|---|---|---|
| Vinyl acetate | 70.00 | 70.00 | 70.00 | 65.81 | 65.81 | 66.49 | 65.79 | 62.29 | 65.81 | 62.29 | 70.00 |
| 2-ethyl hexyl | 10.00 | | | 9.40 | 9.40 | 9.50 | 9.40 | 8.90 | 9.40 | 8.90 | 10.00 |
| acrylate | | | | | | | | | | | |
| Veova 10 | 20.00 | 20.00 | 19.00 | 18.80 | 18.80 | 19.00 | 18.80 | 17.80 | 18.80 | 17.80 | 17.00 |
| HEMA | | | 1.00 | 0.98 | | | 1.01 | 1.00 | 0.98 | 1.00 | |
| Isobornyl | | 10.00 | 10.00 | 5.01 | 5.01 | | | | | | |
| methacrylate | | | | | | | | | | | |
| Hydroxypropyl | | | | | 0.98 | | | | | | |
| methacrylate | | | | | | | | | | | |
| Benzyl | | | | | | 5.01 | 5.00 | 10.01 | 5.01 | 10.01 | 3.00 |
| methacrylate | | | | | | | | | | | |

### Example 2. Performance Testing

Intumescent coating compositions or formulations 1 to 8 were made using the polymer emulsions from Example 1 and including the formulation components shown in Table 2.

TABLE 2
Intumescent Formulation Components

| Raw material | % by weight |
|---|---|
| Pre gel | |
| Water | 9.7 |
| Ammonia | 0.03 |
| Cellulose Ether thickener | 0.27 |
| Paint | |
| Dispersing agent | 0.45 |
| Defoamer | 0.2 |
| Vinyl Acrylic Emulsion/latex | 34.0 |
| Titanium Dioxide | 10.5 |
| Melamine | 9.55 |
| Mono Pentaerythritol | 9.55 |
| Propylene Glycol | 1.6 |
| Ammonium Polyphosphate | 24.0 |
| Total | 100 |

A pre-gel was made using all the water present together with ammonia and cellulose ether thickener. These were high-speed mixed for 15 minutes to ensure the mixture is fully dispersed and lump-free. The pre-gel was mixed with the latex/emulsion from Example 1, and then defoamer and the dispersing agent were added and mixed for 5 minutes. The titanium dioxide, melamine, and mono pentaerythritol were added individually followed by propylene glycol and mixed for 15-20 minutes. Ammonium polyphosphate was added slowly and mixed in for 5 minutes. The maximum temperature during the manufacture of the paints was 28.5° C.

Each formulation was drawn down pre-primed aluminum Q panels (0.32 mm) at wet film thickness (WFT) of 800 μm aiming for a dry film thickness (DFT) of 400 to 500 μm. The coated panels were then left to dry for 7 days at 23° C. 50% relative humidity, before performing Lab Meker tests.

### Example 3. Performance Testing

The coated panels were subjected to Lab Meker testing as described above. Results are shown in Table 3. As can be seen from these results, the introduction of a hydroxyl-containing acrylic monomer improves slumping, char structure and water resistance and slows the rate of expansion, whereas the introduction of benzyl methacrylate exhibited poor expansion characteristics.

TABLE 3
Lab Meker Test Results

| Property | Control | 1 | 2 | 3 | 4 | 5 | 6 | 7 | 8 | 9 | 10 |
|---|---|---|---|---|---|---|---|---|---|---|---|
| Char | Large | Excellent/ | Excellent/ | Excellent/ | Mix of | excellent | Good | Open | good | large | good |
| structure | air pocket | tight | tight | tight | both open | aeration | open | aeration | open | air | open |
| | poor | aeration, | aeration, | aeration | and tight | | aeration | with a | aeration | pocket, | aeration |
| | aeration | | | | aeration | | | large air | | under | |
| | | | | | | | | pocket | | surface | |
| Charring | Yes | controlled | controlled | no | no | No | No | No | No | No | No |
| foam | | | | | | | | | | | |
| slumped | | | | | | | | | | | |
| Char | 25.5 | 34 | 36 | 36 | 33 | 31 | 31.5 | 34 | 19 | 22 | 29 |
| thickness | | | | | | | | | | | |
| (mm) | | | | | | | | | | | |
| Char | 51 | 54 | 54 | 57 | 50 | 53 | 54 | 60 | 35 | 41 | 47 |
| expansion | | | | | | | | | | | |
| ratio | | | | | | | | | | | |
| Time | 160 | 205 | 190 | 270 | 240 | 190 | 210 | 260 | 85 | 80 | 150 |
| taken for | | | | | | | | | | | |
| charring | | | | | | | | | | | |
| foam to | | | | | | | | | | | |
| complete | | | | | | | | | | | |
| expansion | | | | | | | | | | | |
| (seconds) | | | | | | | | | | | |
| % water | >50 | 80 | >85 | 71 | >85 | >90 | >90 | 73 | 88 | >90 | >85 |
| resistance | | | | | | | | | | | |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1. A water-based liquid intumescent coating, comprising:
a binder resin component comprising a vinyl ester emulsion and at least one ethylenically unsaturated comonomer;
a blowing agent; and
an intumescent additive package comprising at least one of an acid source and a carbon source.

2. The composition of claim 1, wherein the vinyl ester emulsion is derived from at least one monomer selected from vinyl toluene, vinyl chloride, vinyl acetate, vinylidine chloride, vinyl versatate ester, and mixtures or combinations thereof, and wherein the composition is substantially free of styrene.

3. The composition of claim 1, wherein the vinyl ester emulsion further includes components derived from at least one monomer selected from ethyl methacrylate, ethyl methacrylate, n-butyl methacrylate, isobutyl methacrylate, t-butyl methacrylate, 2-ethylhexyl acrylate, methyl acrylate, ethyl acrylate, n-butyl acrylate, isobutyl acrylate, t-butyl acrylate, 2-ethylhexyl acrylate, and mixtures or combinations thereof.

4. The composition of claim 1, wherein the at least one ethylenically unsaturated comonomer is a cyclic or aromatic (meth)acrylate monomer.

5. The composition of claim 1, wherein the at least one ethylenically unsaturated comonomer is selected from the group consisting of isobornyl (meth)acrylate, cyclohexyl (meth)acrylate, benzyl (meth)acrylate, and mixtures or combinations thereof.

6. The composition of claim 1, wherein the at least one ethylenically unsaturated comonomer is a hydroxyl-functional (meth)acrylate.

7. The composition of claim 1, wherein the binder resin component is present in an amount of about 10 to 60 wt %, based on the total weight of the composition.

8. (canceled)

9. The composition of claim 1, wherein the at least one ethylenically unsaturated comonomer is present in an amount of about 1 to 15 wt %, based on the total weight of the binder resin component.

10. (canceled)

11. The composition of claim 1, wherein the vinyl ester emulsion is present in an amount of about 50 to 80 wt %, based on the total weight of the binder resin component.

12. (canceled)

13. The composition of claim 1, wherein the binder resin component further comprises one or more ethylenically unsaturated monomers present in an amount of 1 to 25 wt %, based on the total weight of the binder resin component.

14. (canceled)

15. The composition of claim 1, wherein the blowing agent is selected from silane, melamine, melamine formaldehyde, or combinations thereof.

16. (canceled)

17. The composition of claim 1, wherein the blowing agent is present in an amount of about 5 to 10 wt %, based on the total weight of the composition.

18. The composition of claim 1, wherein the acid source is selected from ammonium polyphosphate, melamine phosphate, magnesium sulphate, boric acid, and mixtures or combinations thereof.

19. (canceled)

20. (canceled)

21. The composition of claim 1, wherein the acid source is present in an amount of 35 to 65 wt %, based on the total weight of the intumescent additive package.

22. The composition of claim 1, wherein the carbon source is selected from a polyhydric alcohol, a starch, expandable graphite, and mixtures and combinations thereof.

23. (canceled)

24. (canceled)

25. The composition of claim 1, wherein the carbon source is present in an amount of about 5 to 40 wt %, based on the total weight of the intumescent additive package.

26. A method of making the water-based liquid intumescent coating composition of claim 1, comprising:
providing a binder resin component;
adding a free radical polymerization initiator;
mixing to provide a polymerized latex; and
combining the polymerized latex with the blowing agent and the intumescent additive package.

27. The composition of claim 1, wherein the composition demonstrates optimal char time, char expansion, and water resistance.

28. The composition of claim 1, wherein the composition demonstrates minimal slumping.
